(19) United States
(12) Patent Application Publication
(10) Pub. No.: US 2014/0071477 A1
(43) Pub. Date: Mar. 13, 2014

(54) IMAGE FORMING APPARATUS AND CONTROL METHOD THEREOF

(71) Applicant: CANON KABUSHIKI KAISHA, Tokyo (JP)

(72) Inventor: Minoru Akazawa, Kawasaki-shi (JP)

(73) Assignee: CANON KABUSHIKI KAISHA, Tokyo (JP)

(21) Appl. No.: 14/018,219

(22) Filed: Sep. 4, 2013

(30) Foreign Application Priority Data
Sep. 10, 2012 (JP) 2012-198834

(51) Int. Cl. H04N 1/00; H04N 1/21

(52) U.S. Cl. CPC H04N 1/00896; H04N 1/21
USPC 358/1.14

(57) ABSTRACT

A CPU of a multifunction peripheral which stores unprocessed data (e.g., untransmitted facsimile transmission data, unprinted facsimile reception data etc.) in a RAM is configured not to perform auto shutdown processing if unprocessed data is stored in the RAM, even if an auto shutdown has been set.

### BACKGROUND OF THE INVENTION

1. Field of the Invention

The present invention relates to control of an image forming apparatus including a volatile memory for data storage and capable of power saving.

2. Description of the Related Art

Conventionally, many image forming apparatuses (business machines) such as facsimile machines are configured to enter a sleep mode when they are not used for a long time. In other words, when such image forming apparatuses are not used for a long time, power supplied to the apparatuses stops and power consumption can be reduced. In the sleep mode, power is supplied to minimum portions of an apparatus. Thus, the apparatus can start, for example, according to a key input by a user via an operation unit, reception of a facsimile from a line, or an off-hook operation of a handset.

On the other hand, in the business machine industry in recent years, according to rising momentum in energy conservation, there are apparatuses which incorporate a function called “auto shutdown”. According to this auto shutdown function, if an apparatus stays continuously in a waiting state for a long time, a main power is automatically turned off.

Unlike the sleep mode, when the auto shutdown is performed, power supplied to the apparatus is completely stopped since the main power supply is turned off. This causes a problem with a business machine which incorporates the auto shutdown function and also has a facsimile function as well. In other words, regarding such a business machine, since the main power supply may be turned off when the business machine is in a standby state, the machine may not be able to receive a facsimile or transmit a transmission-standby file at a designated transmission time.

However, the auto shutdown function offers benefits when the business machine is not used, for example, during non-working time at night or on holidays. This is because power supply is automatically stopped and useless power consumption can be avoided.

Under such circumstances, Japanese Patent No. 3400619 discusses a technique useful for reducing power consumption by providing an auto shutdown function to a facsimile apparatus. According to Japanese Patent No. 3400619, supplying power continuously for 24 hours means consuming useless power even for a facsimile apparatus. Thus, if the apparatus is determined to be in the standby state, power supplied to the apparatus is turned off.

Further, in Asian countries, especially in China, when the working staffs leave the office and go back home, they generally turn off the power of the business machine. Under such circumstances, it is considered that needs for reducing useless power consumption by utilizing the auto shutdown function will be prioritized over constant transmission/reception of facsimiles in the future even for the facsimile apparatus.

In providing the auto shutdown function to the facsimile apparatus, it is necessary to determine the way to handle a case where image data is stored in a memory when a time-designated transmission or memory reception is set.

Generally, low-cost facsimile machines are not equipped with a non-volatile memory for cost reasons. The non-volatile memory is, for example, a hard disk (HDD) or a flash memory used for storing image data. Thus, if the main power supply is turned off according to an auto shutdown while image data is stored in the non-volatile memory, all data will be lost.

Actually, when power stops for reasons such as power failure, power is generally fed to the volatile memory from a secondary battery or a super capacitor for data backup. However, if a guarantee period of the battery backup elapses, it may result in loss of data.

Japanese Patent Application Laid-Open No. 2003-274058 discusses a technique useful for a facsimile machine equipped with a mounting unit of a non-volatile memory. According to this technique, presence of a non-volatile memory, such as an HDD or a flash memory, is detected and whether transition to an energy conservation mode is possible can be determined. When the power supplied to the volatile memory is turned off, the facsimile machine can be said to be in the energy conservation mode.

However, unlike the facsimile machine discussed in Japanese Patent Application Laid-Open No. 2003-274058, there are facsimile machines not equipped with a mounting unit of a non-volatile memory. Further, even if a facsimile machine has a mounting unit for a non-volatile memory, since it is necessary to retract data from the volatile memory and store it in the mounted non-volatile memory before the power supply stops, the design for the apparatus will be complicated.

The present invention aims at solving the above-described problems.

The present invention provides a simple configuration of an image forming apparatus which can prevent loss of unprocessed data (e.g., untransmitted facsimile transmission data, unprinted facsimile reception data) stored in a volatile memory even if an auto shutdown has been set to the image forming apparatus. In other words, a complicated configuration required for retracting data stored in the volatile memory to an externally-mounted non-volatile memory is not necessary.

### SUMMARY OF THE INVENTION

The present invention is directed to an image forming apparatus.

According to an aspect of the present invention, an image forming apparatus includes a storage unit which is volatile and configured to store received data and a control unit configured to execute processing for stopping power supply to the storage unit, wherein if data to be printed by the image forming apparatus is stored in the storage unit, the control unit does not execute the processing for stopping the power supply to the storage unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an example of an image forming apparatus according to an exemplary embodiment of the present invention.

FIG. 2 is a flowchart illustrating an example of an operation of a multifunction peripheral when a main power switch is turned on by a user.

FIGS. 3A and 3B illustrate examples of a configuration of the main power switch.

FIGS. 4A and 4B illustrate examples of a display/setting screen for displaying and setting a sleep mode and an auto shutdown of an operation unit.

FIG. 5 illustrates an example of the display/setting screen for displaying and setting memory reception of a facsimile on the operation unit.

### DESCRIPTION OF THE EMBODIMENTS

Various exemplary embodiments, features, and aspects of the invention will be described in detail below with reference to the drawings.

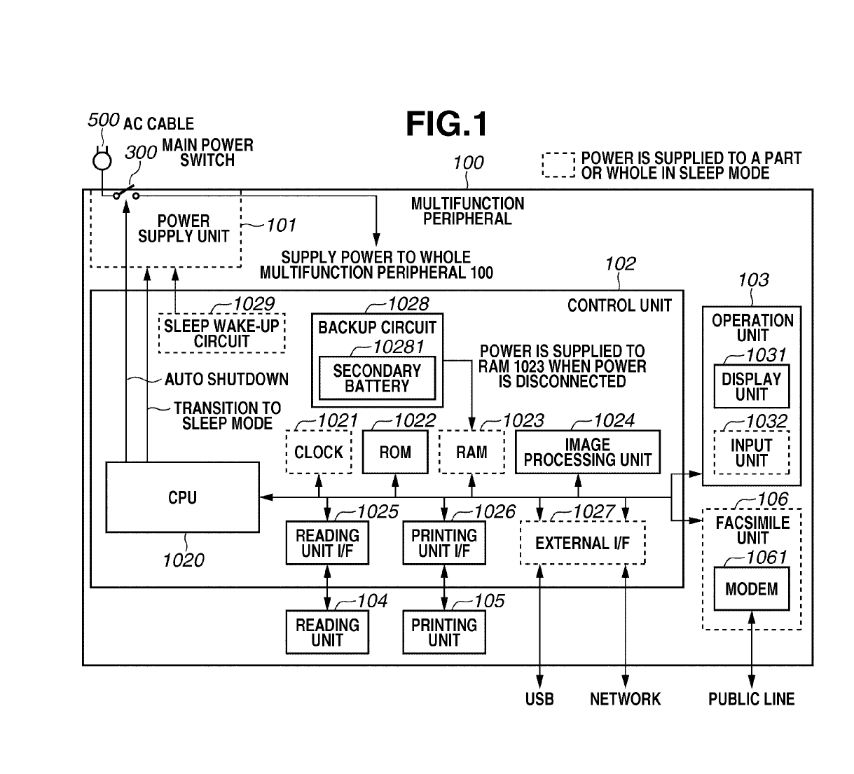

FIG. 1 is a block diagram illustrating an example of an image forming apparatus according to an exemplary embodiment of the present invention.

In FIG. 1, a multifunction peripheral 100 is the image forming apparatus of the present embodiment, and has a facsimile transmission/reception function.

The multifunction peripheral 100 includes a power supply unit 101, a control unit 102, an operation unit 103, a reading unit 104, a printing unit 105, and a facsimile unit 106.

The power supply unit 101 is connected to an external commercial power source via an AC cable 500 and supplies necessary power to the multifunction peripheral 100. The power supply unit 101 can supply power when a main power switch 300 is turned on.

The control unit 102 controls an operation of the multifunction peripheral 100. For example, the control unit 102 controls a facsimile transmission, an image reading operation, and a printing operation. Details of the control unit 102 will be described below.

The operation unit 103 includes a display unit 1031 and an input unit 1032. The display unit 1031 includes a liquid crystal display (LCD) or a quarter video graphics array (QVGA). The input unit 1032 includes a numeric keypad, a push button, and a touch panel.

The display unit 1031 displays information of the operation of the multifunction peripheral 100 such as setting and a state. For example, the display unit 1031 displays a setting of time-designated transmission and a setting state of memory reception. When the time-designated transmission is set, image data which has been read by the reading unit 104 can be transmitted by facsimile at a designated time (date and time). When the memory reception is set, image data received by facsimile is stored in a memory instead of being output by printing. Further, if image data which has been transmitted by the time-designated transmission or image data which has been received by the memory reception exits in the memory, information of such a state is displayed on the display unit 1031.

The user can set the settings for the operation of the multifunction peripheral 100 and also start the operation of the multifunction peripheral 100 via the input unit 1032. For example, the user can set a mode regarding facsimile transmission/reception via the input unit 1032. The transmission mode of facsimile includes the time-designated transmission, and the reception mode of facsimile includes the memory reception as well as normal reception.

Further, the user can set the settings for a sleep mode and an auto shutdown via the input unit 1032. Regarding the setting of the sleep mode, the user inputs a sleep mode transition time, which is the time necessary for the transition of the multifunction peripheral 100, in a standby state, to the sleep mode. Regarding the setting of the auto shutdown, the user inputs whether the auto shutdown is to be executed. Further, if the auto shutdown is to be executed, the user inputs an auto shutdown execution time. The auto shutdown execution time is the time necessary for the execution of the auto shutdown for the multifunction peripheral 100 in the sleep state.

The reading unit 104 includes an optical element such as a charge-coupled device (CCD) or a contact image sensor (CIS). The reading unit 104 reads a document which has been set, converts obtained data into image data, and transfers the image data to the control unit 102. The transferred image data is subjected to necessary image processing according to the control of the control unit 102. Then, the processed data is subjected to facsimile transmission processing or print processing.

The printing unit 105 incorporates an electrophotographic mechanism. The printing unit 105 prints print data, which has been transferred from the control unit 102, on paper which has been set.

The facsimile unit 106 includes a modem 1061. According to an instruction from the control unit 102, the facsimile unit 106 modulates facsimile data to be transmitted and transmits it to a destination via an external public line. Further, the facsimile unit 106 demodulates received facsimile data and transfers it to the control unit 102.

The control unit 102 will now be described in detail.

The control unit 102 includes a central processing unit (CPU) 1020, a clock 1021, a read-only memory (ROM) 1022, a random access memory (RAM) 1023, an image processing unit 1024, a reading unit I/F 1025, a printing unit I/F 1026, an external I/F 1027, a backup circuit 1028, and a sleep wake-up circuit 1029.

The CPU 1020 controls an internal operation of the multifunction peripheral 100 as well as an operation of the multifunction peripheral 100 with an external device. For example, the CPU 1020 controls procedures regarding facsimile transmission, and performs image data control and power control of the multifunction peripheral 100. According to the power control performed by the CPU 1020, the multifunction peripheral 100 is set to the sleep mode (power saving state) or subjected to auto shutdown. When the multifunction peripheral 100 is in the sleep mode, some of the power supplied to the multifunction peripheral 100 stops. The multifunction peripheral 100 can return to the standby state when a wake-up factor is determined. Further, when the auto shutdown of the multifunction peripheral 100 is performed, since the main power switch 300 is turned off, and the power to the multifunction peripheral 100 completely stops, the multifunction peripheral 100 cannot recover by itself.

The CPU 1020 also controls scanning and printing operations. The scanning operation is performed by the reading unit 104. According to an instruction from a host computer which has been transmitted via a network, the reading unit 104 reads a document image and transmits the obtained image to the host computer. The printing operation is performed by the printing unit 105. The printing unit 105 prints print data input by the host computer via a network.

In addition to a clock function, the clock 1021 has a timer function and an alarm function. According to the timer function, a timer time passage signal is generated when the time of the timer set by the CPU 1020 is reached. Further, according to the alarm function, an alarm signal is generated when the time set by the CPU 1020 is reached.

The ROM 1022 is a non-volatile memory and stores an operation program of the CPU 1020. The CPU 1020 reads out the program from the ROM 1022 when the main power switch 300 is turned on and the multifunction peripheral 100 starts.

The RAM 1023 stores image data, which was received by facsimile and has been transferred from the facsimile unit 106, as well as image data, which was read by the reading unit 104 and has been set for the time-designated transmission. Additionally, a program read by the CPU 1020 from the ROM 1022 when the multifunction peripheral 100 starts is loaded to the RAM 1023. Further, the RAM 1023 is used as a work space when image processing is performed.

The image processing unit 1024 incorporates functions for image processing (e.g., compression, decompression, rotation, enlargement, reduction, and rendering) necessary in transmitting a facsimile. The image processing unit 1024 executes image processing of the image data read by the reading unit 104 and data received by the facsimile unit 106 as needed.

The reading unit I/F 1025 communicates with the reading unit 104, receives the image data read by the reading unit 104, and stores it in the RAM 1023.

The printing unit I/F 1026 communicates with the printing unit 105 and transfers data printable by the printing unit 105 to the printing unit 105. Such data is, for example, data received by the facsimile unit 106 and subjected to necessary image processing performed by the image processing unit 1024.

The external I/F 1027 is connected to a host computer (not illustrated) via a connection configuration such as a universal serial bus (USB) or a network. Print data sent from the host computer is subjected to necessary image processing performed by the image processing unit 1024 and printed by the printing unit 105.

The backup circuit 1028 includes a secondary battery 10281. The secondary battery 10281 is charged by the power supplied from the power supply unit 101. Further, the backup circuit 1028 monitors the power supplied from the power supply unit 101. When the power supplied from the power supply unit 101 stops, the backup circuit 1028 changes the power source of the RAM 1023 from the power supply unit 101 to the secondary battery 10281. According to this operation, even if a power failure occurs, data stored in the RAM 1023, such as time-designated transmission data and memory reception data, can be protected from data loss. However, there is a certain limit in the backup time of the secondary battery 10281.

For example, backup of one hour is guaranteed by charging of two hours. Thus, if power is not recovered within the backup time, data stored in the RAM 1023 will be lost.

The sleep wake-up circuit 1029 restarts the supply of power to the power supply unit 101. More precisely, when the multifunction peripheral 100 is in the sleep mode according to the power control of the CPU 1020, if the sleep wake-up circuit 1029 receives a sleep wake-up factor described below, the sleep wake-up circuit 1029 restarts the supply of power to the power supply unit 101.

### <Sleep Mode>

The transition to the sleep mode and the sleep wake-up will be described with reference to FIG. 1.

First, the power supply unit 101 includes a first power supply unit and a second power supply unit. Regarding the first power supply unit, even if the mode of the multifunction peripheral 100 is changed to the sleep mode, power is continuously supplied to the multifunction peripheral 100. Regarding the second power supply unit, if the mode is changed to the sleep mode, power to the multifunction peripheral 100 will stop.

Power from the first power supply unit is supplied to the areas surrounded by dotted lines illustrated in FIG. 1. In other words, in addition to the power supply unit 101 itself, the power supply unit 101 supplies power to the clock 1021, the RAM 1023, the external I/F 1027, the sleep wake-up circuit 1029, the input unit 1032, and the facsimile unit 106 from the first power supply unit. The power supply unit 101 supplies power to other units from the second power supply unit. Regarding the input unit 1032 and the facsimile unit 106, the first power supply unit is supplied only to a circuit of a sleep wake-up button and a detection circuit of facsimile reception of the facsimile unit 106.

The CPU 1020 determines whether the setting regarding transition to the sleep mode via the input unit 1032 is set, accepts a sleep mode transition factor, and instructs the power supply unit 101 to stop the power supply of the second power supply unit. The sleep mode transition factor is, for example, a timer time passage signal which is generated after the elapse of time set to the clock 1021 according to the setting of the sleep mode transition time via the input unit 1032, and a case where the user presses a sleep transition button of the input unit 1032.

When the power supply from the second power supply unit stops, power will not be supplied to the CPU 1020. Thus, before the multifunction peripheral 100 is changed to the sleep mode, the CPU 1020 collects a register setting value set to the multifunction peripheral 100 and stores the value in the RAM 1023. Then, the CPU 1020 stops the second power supply unit.

Further, the sleep wake-up circuit 1029 receives the sleep wake-up factor, and instructs the power supply unit 101 to restart power supply of the second power supply unit. The sleep wake-up factor is, for example, a case where the user presses a sleep wake-up button (not illustrated) of the input unit 1032, a case where the external I/F 1027 receives a print request from the host computer, and a case where the facsimile unit 106 detects reception of a facsimile. Further, generation of the timer time passage signal output from the clock 1021 and generation of an alarm signal correspond to the sleep wake-up factor.

When the multifunction peripheral 100 starts by the supply of the second power supply unit according to the sleep wake-up factor, the CPU 1020 first reads the setting value of the multifunction peripheral 100 which has been stored in the RAM 1023 at the time of transition to the sleep mode. Then, the CPU 1020 sets a predetermined setting and the multifunction peripheral 100 restores the state before the transition to the sleep mode.

In this manner, according to the transition to the sleep mode and the wake-up, the second power supply unit stops during the unused period of the multifunction peripheral 100. Accordingly, the power consumption is reduced compared to when the multifunction peripheral 100 stays in the standby state.

### <Time-Designated Transmission>

Next, the time-designated facsimile transmission will be described with reference to FIG. 1.

As described above, among the functions of the facsimile transmission, there is a function of time-designated transmission. According to the time-designated transmission, the image data obtained by the reading of the reading unit 104 and stored in the RAM 1023 is transmitted at the time designated by the user. The setting of the time-designated transmission is performed by the user via the operation unit 103. If the time-designated transmission is set, the CPU 1020 sets the designated transmission time to the clock 1021 for the alarm. Thus, when the time which has been set comes, the clock 1021 generates an alarm signal. On receiving the alarm signal, the CPU 1020 transmits the image data for the time-designated transmission stored in the RAM 1023 via the facsimile unit 106.

If the clock 1021 generates the alarm signal when the multifunction peripheral 100 is in the sleep mode, the sleep wake-up circuit 1029 receives the alarm signal as the sleep wake-up factor and instructs the power supply unit 101 to supply the second power supply unit. Accordingly, the CPU 1020 starts and the time-designated transmission is executed.

### <Memory Reception>

Memory reception of a facsimile will now be described with reference to FIG. 1.

A case where image data, which has been received by facsimile transmission, is not immediately printed and stored in the RAM 1023 for a predetermined length of time is called memory reception. The memory reception includes confidential reception, which is set when the multifunction peripheral 100 is shared by a plurality of users, and forced memory reception. When the confidential reception is set, the received image data is purposely not printed so that it cannot be seen by others. The forced memory reception works when the printing unit 105 is out of toner, ink, or paper and unable to print the image data. In such a case the printing unit 105 does not retrieve data from the RAM 1023.

According to the confidential reception, the receiver is asked to enter, for example, an ID number unique to the receiver via the operation unit 103 so that the receiver can be identified. If the authentication of the receiver is successful, image data is retrieved from the RAM 1023 and the printing is performed. In the case of forced memory reception, when toner, ink, or paper is supplied, image data is retrieved from the RAM 1023 having the supply as a trigger. Then, the printing is performed.

Regarding the memory reception, in either case, since image data needs to be stored in the RAM 1023 for a predetermined length of time, the mode may be changed to the sleep mode during that time. However, since the first power supply unit is supplied to the RAM 1023, the image data can be stored until the sleep wake-up.

### <Auto Shutdown>

The operation of the auto shutdown will be described with reference to FIG. 1.

The auto shutdown is a function used for cutting power consumption when the multifunction peripheral 100 is in the standby state by completely stopping the power supply. The auto shutdown is executed if a predetermined condition is satisfied (prolonged unused state).

Thus, if the multifunction peripheral 100 is changed to the sleep mode (standby) and the sleep wake-up factor does not occur within a predetermined period of time, the auto shutdown processing will be performed. The predetermined period of time (auto shutdown execution time) is set by the user via the input unit 1032.

When the CPU 1020 accepts the sleep mode transition factor, first, the CPU 1020 determines whether image data is stored in the RAM 1023. If image data is not stored in the RAM 1023, the CPU 1020 sets to the clock 1021 the time after the transition to the sleep mode and before the execution of the auto shutdown. The time is set by the user via the input unit 1032. Then, the multifunction peripheral 100 is changed to the sleep mode. When the CPU 1020 receives a timer time passage signal of the execution of the auto shutdown, the CPU 1020 turns off the main power switch 300.

The reason for the CPU 1020 determining the presence of the image data in the RAM 1023 before the mode is changed to the sleep mode is to avoid loss of image data in the RAM 1023 in a case where the auto shutdown is immediately performed. Actually, even if the main power switch 300 is turned off, the secondary battery 10281 of the backup circuit 1028 performs backup for a predetermined length of time. However, if the main power switch 300 is not turned on during the period, the image data stored in the RAM 1023 will be lost. Thus, according to the present invention, in order to avoid such a situation, even if the auto shutdown is set via the input unit 1032, if image data is stored in the RAM 1023, the multifunction peripheral 100 remains in the sleep state and the auto shutdown will not be performed.

According to the present invention, the image data stored in the RAM 1023 is image data stored for the above-described time-designated transmission, image data received by memory reception when confidential receiving has been set, or image data received by memory reception when the printing unit 105 is short of toner, ink, or paper. Actually, however, if image data or other data which may cause the user trouble when the data is lost exists, such data may also be included in the above-described data.

The CPU 1020 may control the RAM 1023 so that, when the auto shutdown is executed (or when the mode is changed to the sleep mode), the mode of the RAM 1023 can be changed to the self-refresh mode.

### <Main Power Switch 300>

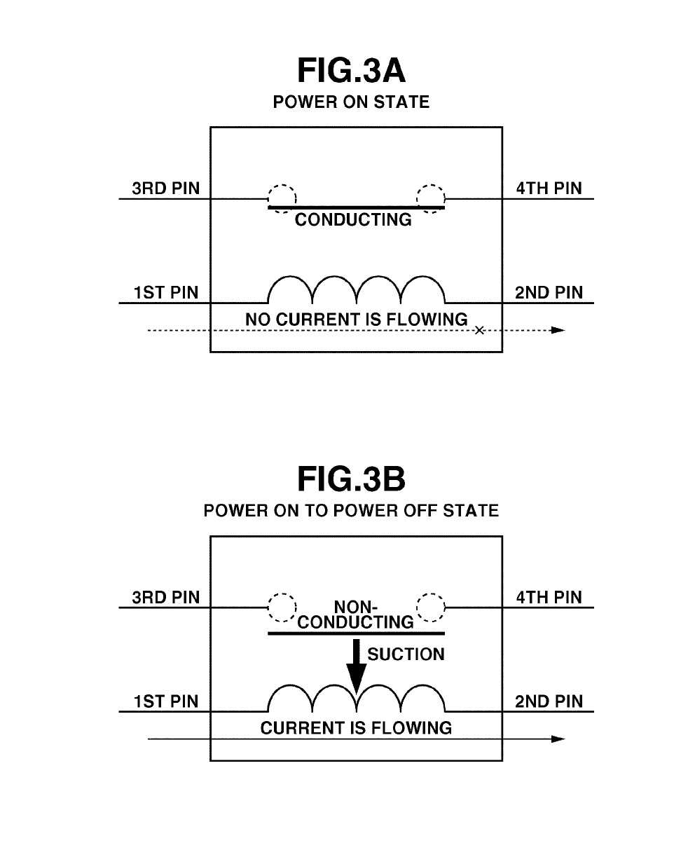

Then, the main power switch 300 will be described with reference to FIGS. 3A and 3B.

FIGS. 3A and 3B illustrate examples of a configuration of the main power switch 300.

The main power switch 300 includes a latching solenoid.

FIG. 3A illustrates the main power switch 300 when it is turned on (power switch is ON). In this state, since a current does not pass through a pull coil that configures an internal solenoid, there is continuity between a 3rd pin and a 4th pin.

A case where the main power switch 300 is turned off by the control of the CPU 1020 when the main power switch 300 is in the state illustrated in FIG. 3A will be described with reference to FIG. 3B.

FIG. 3B illustrates a state of the main power switch 300 when the main power switch 300 is turned off from the power-on state. First, the pull coil, which is connected to a 1st pin and a 2nd pin, is excited by an application of an electric current to the coil by the control of the CPU 1020, and a current-carrying movable portion that connects the 3rd pin and the 4th pin is suctioned to the side of the coil. This state can be continuously maintained by a holding power of a built-in permanent magnet (not illustrated) (operating principle of a latching solenoid). Accordingly, by the control of the CPU 1020, the conduction between the 3rd pin and the 4th pin can be disconnected, and the main power switch 300 is turned off.

On the contrary, if the main power switch 300 is turned on from the power-off state, the user needs to turn on the main power switch 300.

The pin arrangement of the main power switch 300 is not limited to the example illustrated in FIGS. 3A and 3B.

Further, the main power switch 300 that includes the latching solenoid also includes a seesaw switch. Thus, the power can be turned off by an external factor such as the user.

### <Operation of the Multifunction Peripheral 100>

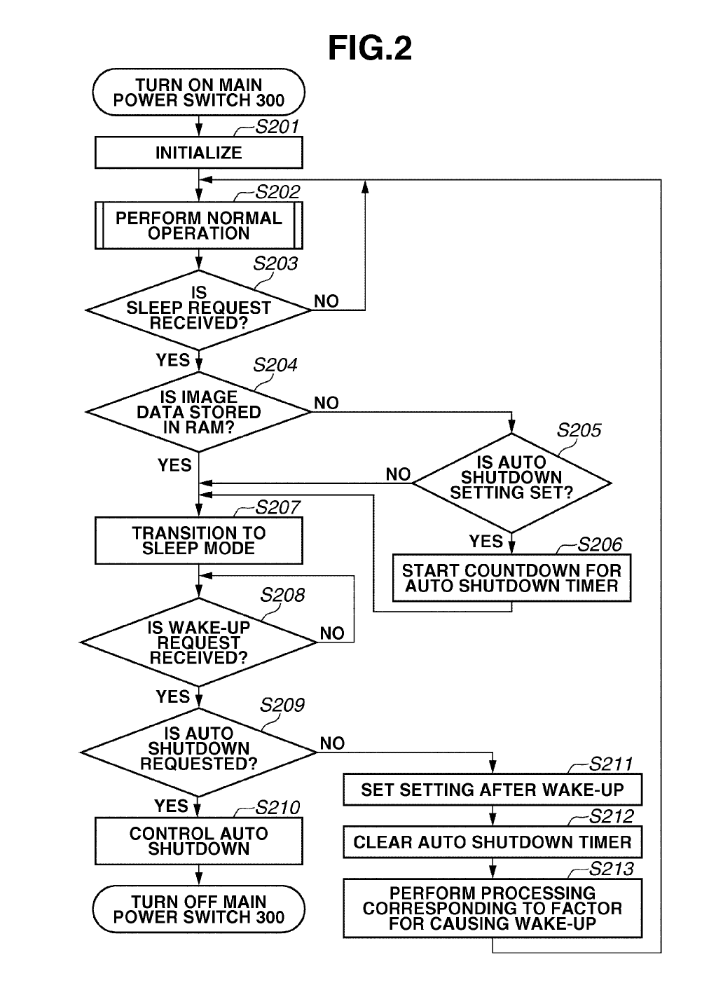

FIG. 2 is a flowchart illustrating an example of an operation of the multifunction peripheral 100 when the main power switch 300 is turned on by the user. This flowchart is realized by the user turning on the main power switch 300 and the CPU 1020 reading out a computer-readable program from the ROM 1022, loading it to the RAM 1023, and executing it.

In step S201, the CPU 1020 initializes the multifunction peripheral 100. According to the initialization, for example, an input/output setting and an initial value setting of a port of the CPU 1020 itself as well as an initial value setting of the register of each module of the image processing unit 1024 are set.

When the initialization of the multifunction peripheral 100 in step S201 is finished, the display unit 1031 displays a default screen. Then, each of the input unit 1032, the external I/F 1027, and the modem 1061 is changed to an input-acceptable state regarding the input from an external device. Then, the processing proceeds to step S202.

In step S202, the CPU 1020 accepts various inputs of the multifunction peripheral 100, and performs the settings and normal operations regarding copying, printing, and facsimile transmission/reception. Settings of the above-described time-designated facsimile transmission and memory reception are also set in this step. Further, in step S202, the CPU 1020 accepts the settings of the sleep mode and the auto shutdown from the input unit 1032.

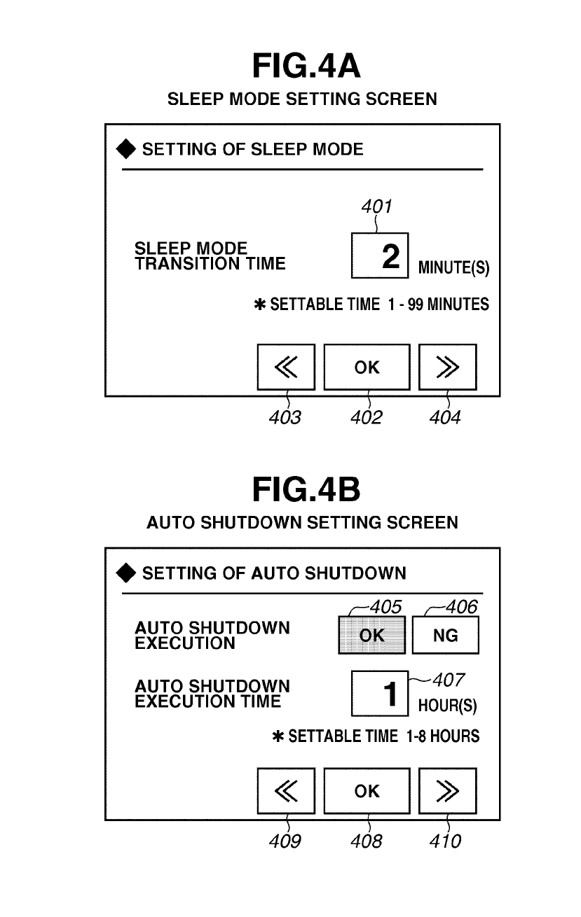

Details of the setting of the sleep mode and the auto shutdown will be described with reference to FIGS. 4A and 4B.

FIGS. 4A and 4B illustrate examples of a display/setting screen of the sleep mode and the auto shutdown of the operation unit 103.

According to the control by the CPU 1020, the screens illustrated in FIGS. 4A and 4B are displayed by the display unit 1031 of the operation unit 103. The operation unit 103 includes a touch panel, and the input unit 1032 is included in the display unit 1031. By the user operating the input unit 1032, the default screen can be changed to each setting screen.

The user inputs one value selected from 1 to 99 in a box of sleep mode transition time 401 on a sleep mode setting screen illustrated in FIG. 4A. Although the default time is 2 minutes, the user can decrease the time by one minute by using a left button 403 and increase the time by one minute by using a right button 404.

The time displayed in the box of the sleep mode transition time 401 when the user presses an OK button 402 is set as the sleep mode transition time. According to the setting of the sleep mode transition time set by the user, the CPU 1020 sets the sleep mode transition time to the clock 1021.

The CPU 1020 starts countdown of the timer each time a job, such as copying, printing, or facsimile transmission/reception, which has been input in the multifunction peripheral 100, ends. If a job is generated before the timer time passage signal is generated, the CPU 1020 clears and controls the timer so that the timer is set again to the above-described setting value.

According to an auto shutdown setting screen illustrated in FIG. 4B, the user is asked to press either an auto shutdown execution OK button 405 or an auto shutdown execution NG button 406, and to set whether to execute the auto shutdown.

If the user presses the auto shutdown execution OK button 405, the CPU 1020 enables input in a box of auto shutdown execution time 407. Although the default time is 1 hour, the user can decrease the time by one hour by using a left button 409 and increase the time by one hour by using a right button 410. The user inputs one value selected from 1 to 8.

Further, if the user presses an OK button 408, the time set in the box of the auto shutdown execution time 407 is set as the time necessary for the execution of the auto shutdown from the sleep state.

On receiving the input of the auto shutdown setting, the CPU 1020 determines whether the auto shutdown is to be executed. If the CPU 1020 determines that the auto shutdown is to be executed, the CPU 1020 sets the auto shutdown execution time input by the user to the clock 1021.

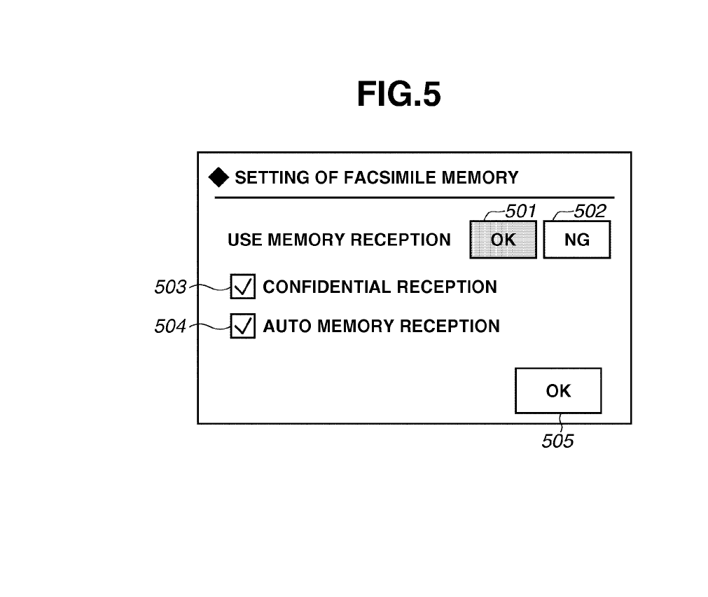

Now, the setting of memory reception of facsimile will be described in detail with reference to FIG. 5.

FIG. 5 illustrates an example of a display/setting screen of the memory reception of facsimile displayed on the operation unit 103.

The screen illustrated in FIG. 5 is displayed on the display unit 1031 of the operation unit 103 according to the control of the CPU 1020. The user can change the default screen to this setting screen by operating the input unit 1032.

On the setting screen of the memory reception of facsimile illustrated in FIG. 5, the user is asked to press either a memory reception execution OK button 501 or a memory reception execution NG button 502, and to set whether to use the memory reception function of facsimile. If the user presses the memory reception execution OK button 501, the CPU 1020 enables input of a confidential receiving check box 503 and an auto memory reception check box 504.

Then, the setting which has been set when the user pressed an OK button 505 is set as the setting for the memory reception of facsimile.

The flowchart illustrated in FIG. 2 will be referred back again.

In step S203, the CPU 1020 determines whether the sleep mode transition factor has been received.

If the CPU 1020 determines that the sleep mode transition factor has not yet been received (NO in step S203), the processing returns to step S202.

On the other hand, if the CPU 1020 determines that the sleep mode transition factor has been received (e.g., the timer time passage signal has been generated by the clock 1021 according to the setting of the above-described sleep mode transition time) (YES in step S203), the processing proceeds to step S204.

In step S204, the CPU 1020 determines whether image data is stored in the RAM 1023. The image data stored in the RAM 1023 is, for example, image data regarding the time-designated facsimile transmission or memory reception. Further, if data (not limited to image data) which will cause the user trouble when it is lost exists, such data can also be included in the above-described data.

If the CPU 1020 determines that image data is not stored in the RAM 1023 (NO in step S204), the processing proceeds to step S205.

In step S205, the CPU 1020 determines whether the auto shutdown setting is set.

If the CPU 1020 determines that the auto shutdown setting is not set (auto shutdown execution: NG) (NO in step S205), the processing proceeds to step S207.

On the other hand, if the CPU 1020 determines that the auto shutdown setting is set (auto shutdown execution: OK) (YES in step S205), the processing proceeds to step S206.

In step S206, the CPU 1020 starts countdown of the timer of the clock 1021. The auto shutdown execution time is set to the timer. Then, the processing proceeds to step S207.

On the other hand, in step S204, if the CPU 1020 determines that image data is stored in the RAM 1023 (YES in step S204), the CPU 1020 does not start countdown for the auto shutdown of the timer even if the auto shutdown setting has been set, and the processing proceeds to step S207.

In step S207, the CPU 1020 changes the mode of the multifunction peripheral 100 to the sleep mode. When the mode is changed to the sleep mode, as described above, the CPU 1020 collects the setting value set to the multifunction peripheral 100 and stores it in the RAM 1023. Then, the CPU 1020 stops the second power supply unit of the power supply unit 101. Accordingly, the multifunction peripheral 100 enters a state waiting for the sleep wake-up factor.

In step S208, it is determined as to whether a sleep wake-up factor is generated. If a sleep wake-up factor is generated, since the second power supply unit of the power supply unit 101 which has stopped will be turned on by the sleep wake-up circuit 1029, power is supplied to the entire multifunction peripheral 100, and the processing operation of the CPU 1020 can be performed. If the CPU 1020 determines that a sleep wake-up factor is generated (YES in step S208), the processing proceeds to step S209. If the CPU 1020 determines that a sleep wake-up factor is not yet generated (NO in step S208), step S208 will be repeated.

In step S209, the CPU 1020 analyzes the sleep wake-up factor generated in step S208, and determines whether the factor is the generation of a timer time passage signal due to elapse of the auto shutdown execution time (i.e., whether auto shutdown has been requested).

Methods for determining whether the sleep wake-up factor is due to the elapse of the auto shutdown execution time (auto shutdown request) are, for example, as follows.

Before the multifunction peripheral 100 enters the sleep mode in step S207, the CPU 1020 stores the time of the clock 1021 in the RAM 1023. Then, the CPU 1020 obtains the time of the multifunction peripheral 100 when waking up from the sleep mode in step S208 from the clock 1021. If such wake-up time matches the time set as the auto shutdown execution time, the CPU 1020 determines that the sleep wake-up factor is the auto shutdown request.

Further, the presence of the sleep wake-up factor other than the auto shutdown can be determined, for example, by input of an interruption signal to the CPU 1020. The determination methods of the sleep wake-up factor, however, are not limited to the methods described above and any method can be used so long as the sleep wake-up factor can be determined.

In step S209, if the CPU 1020 determines that the sleep wake-up factor is the generation of the timer time passage signal due to elapse of the auto shutdown execution time (i.e., auto shutdown request) (YES in step S209), the processing proceeds to step S210.

In step S210, the CPU 1020 executes the auto shutdown by turning off the main power switch 300 of the power supply unit 101. Since all the power supplied to the multifunction peripheral 100 will stop, the CPU 1020 will not be able to operate, and the processing of the flowchart ends.

On the other hand, in step S209, if the CPU 1020 determines that the sleep wake-up factor is not the generation of the timer time passage signal due to elapse of the auto shutdown execution time (i.e., auto shutdown request) (NO in step S209), the processing proceeds to step S211.

In step S211, the CPU 1020 sets the setting for the multifunction peripheral 100 after the wake-up from the sleep mode. The setting processing for the multifunction peripheral 100 after the wake-up from the sleep mode includes resetting each setting value of the multifunction peripheral 100 stored in the RAM 1023 in step S207 described above when the for the multifunction peripheral 100 entered the sleep mode to a predetermined register, and determining the sleep wake-up factor.

In step S212, the CPU 1020 clears the auto shutdown execution time of the timer of which countdown started in step S206.

In step S213, with respect to the event being the cause of the sleep wake-up factor, the CPU 1020 performs the corresponding processing (processing corresponding to the sleep wake-up factor) if necessary.

For example, if the sleep wake-up factor is an incoming call via the public line and if facsimile reception is necessary, the CPU 1020 performs the reception processing. Further, if the sleep wake-up factor is the user pressing the sleep wake-up button of the input unit 1032, since the CPU 1020 needs only to wait for a further input by the user, the CPU 1020 does not perform processing. In this manner, the CPU 1020 performs various types of processing corresponding to the sleep wake-up factors.

When the processing corresponding to the sleep wake-up factor described above and performed in step S213 ends, the CPU1020 returns the processing to step S202, and controls to perform the normal operation.

As described above, according to the present embodiment, even if the auto shutdown has been set to the multifunction peripheral 100, loss of unprocessed data (e.g., untransmitted facsimile transmission data, unprinted facsimile reception data etc.) stored in a volatile memory such as the RAM 1023 can be prevented by a simple configuration. In other words, a complicated configuration required for retracting data stored in the volatile memory to an externally-mounted non-volatile memory is not necessary.

The configuration and the content of the above-described data are not limited to such an example. For example, data with various configurations and contents can be applied to the present invention.

Although an exemplary embodiment is illustrated in the description above, the present invention can take various embodiments concerning, for example, a system, an apparatus, a method, a program, or a storage medium. In other words, the present invention can be applied to a system including a plurality of apparatuses or to an apparatus configured from one apparatus.

Further, all of a combination of each of the above-described exemplary embodiments is included in the present invention.

Furthermore, the above-described exemplary embodiment can also be achieved by supplying a software program that realizes each function of aforementioned exemplary embodiments to a system or an apparatus via a network or various types of storage media, and a computer (or a CPU or an MPU) in the system or the apparatus reads and executes the program stored in such storage media.

The present invention can be applied to a system including a plurality of devices, or to an apparatus including a single device.

The present invention is not limited to the above-described exemplary embodiments. Various changes (including organic combination of each exemplary embodiment) can be applied so long as they fall within the scope of the present invention. Thus, each exemplary embodiment described above and a combination of the alternate versions are also included in the present invention.

According to the present invention, even if the auto shutdown has been set to the image forming apparatus, loss of unprocessed data stored in the volatile memory can be prevented by a simple configuration.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-198834 filed Sep. 10, 2012, which is hereby incorporated by reference herein in its entirety.

What is claimed is:

1. An image forming apparatus comprising:
a storage unit which is volatile and configured to store received data, and
a control unit configured to execute processing for stopping power supply to the storage unit,
wherein if data to be printed by the image forming apparatus is stored in the storage unit, the control unit does not execute the processing for stopping the power supply to the storage unit.

2. The image forming apparatus according to claim 1, wherein if the data to be printed by the image forming apparatus is not stored in the storage unit, the control unit executes the processing for stopping the power supply to the storage unit.

3. The image forming apparatus according to claim 2, wherein if the data to be printed by the image forming apparatus is not stored in the storage unit and if a predetermined condition is satisfied, the control unit executes the processing for stopping the power supply to the storage unit.

4. The image forming apparatus according to claim 3, wherein the predetermined condition is elapse of a predetermined time in a non-printing state.

5. The image forming apparatus according to claim 1, wherein the data to be printed by the image forming apparatus is fax reception data.

6. The image forming apparatus according to claim 1, wherein the data stored in the storage unit is printed according to a user instruction.

7. The image forming apparatus according to claim 1, further comprising:
a switch which can be in an on state and an off state; and
a solenoid which can change the switch in the on state to the off state,
wherein when executing the processing for stopping the power supply to the storage unit, the control unit drives the solenoid and changes the switch in the on state to the off state.

8. A control method of an image forming apparatus, the method comprising:
storing received data in a storage unit which is volatile, and
if data to be printed by the image forming apparatus is not stored in the storage unit, the control unit executes processing for stopping power supply to the storage unit, and if data to be printed by the image forming apparatus is stored in the storage unit, the control unit does not execute the processing for stopping the power supply to the storage unit.
